(19) United States
(12) Patent Application Publication
(10) Pub. No.: US 2020/0366775 A1
(43) Pub. Date: Nov. 19, 2020

(54) TERMINAL HAVING MOVABLE BUILT-IN CAMERA

(71) Applicants: Jong Sun LEE, Yongin-si (KR); Gwan Woo LEE, Yongin-si (KR); In Seo LEE, Yongin-si (KR); Seo Hyeon LEE, Yongin-si (KR)

(72) Inventors: Jong Sun LEE, Yongin-si (KR); Gwan Woo LEE, Yongin-si (KR); In Seo LEE, Yongin-si (KR); Seo Hyeon LEE, Yongin-si (KR)

(21) Appl. No.: 16/959,964

(22) PCT Filed: Dec. 28, 2018
(86) PCT No.: PCT/KR2018/016911

§ 371 Date: Jul. 2, 2020

(30) Foreign Application Priority Data
Jan. 5, 2018 (KR) 10-2018-0001874
Dec. 14, 2018 (KR) 10-2018-0162420

(51) Int. Cl. H04M 1/02; G06F 1/16; H04N 5/225

(52) U.S. Cl. CPC H04M 1/0264; H04M 2250/20; H04N 5/2252; G06F 1/1686

(57) ABSTRACT

A terminal having a movable built-in camera according to another embodiment of the present invention comprises: a camera capture module which forms an image of incident light reflected from a subject, converts the formed image of light into an electrical signal, and then generates the electrical signal into digital image information (image) of the subject through image signal processing; a direction angle adjustment module which adjusts vertical and horizontal rotation angles of the camera capture module; an image processing module which, on the basis of environment setting information, corrects the position of a particular image captured within a camera capture frame, so as to position the particular image at the center of the camera capture frame; and an environment setting module which provides the environment setting information.

### TECHNICAL FIELD

The present invention relates to a terminal having a movable camera and a photographing method using the same, and more particularly, to a terminal having a movable built-in camera, which can freely move the camera provided in the terminal to allow a user to photograph a desired object.

### BACKGROUND ART

Recently, due to the development of a small camera module, a camera embedded in a mobile phone or the like has a performance comparable to that of a general camera.

In general, a small camera is applied to a smartphone, a laptop computer, etc., and is used not only for a video call but also as a digital camera.

FIG. 1 is a view illustrating a smartphone equipped with a conventional built-in camera which is fixed.

In addition, FIG. 2 is a view illustrating a laptop computer equipped with a mounted camera such as a conventional webcam, in which a mounted external camera is mounted on the laptop computer.

However, in the case of a camera built in or mounted on a conventional terminal, it is inconvenient to focus on a subject while manually moving the position of a terminal or monitor vertically or horizontally due to a fixed built-in camera for taking pictures or videos or video chatting.

In particular, in the case of a laptop computer, when a user adjusts the monitor angle of a laptop computer for video chatting, the monitor screen is often uncomfortable because it does not match the user's viewing angle.

In addition, in the case of a desktop PC, the appearance of the external detachable video camera is poor in aesthetics and it is inconvenient to use it

### DISCLOSURE

### Technical Problem

An object of the present invention is to provide means for automatically or manually changing the photographing direction of a built-in camera.

An object of the present invention is to provide means for automatically correcting a position of a person image in a camera frame to the center of the camera frame through artificial intelligence.

### Technical Solution

According to an aspect of the present invention, there is provided a terminal having a movable built-in camera, which includes a camera capture module configured to form an image of incident light reflected from a subject, and convert the formed image of light into an electrical signal to generate digital image information (image) of the subject through image signal processing; a direction angle adjustment module configured to adjust vertical and horizontal rotation angles of the camera capture module; an image processing module configured to correct a position of a specific image captured within a camera capture frame to position the specific image at a center of the camera capture frame based on environment setting information; and an environment setting module configured to provide the environment setting information.

### Advantageous Effects

According to the embodiments of the present invention, it is possible to improve user convenience by automatically or manually changing the photographing direction of the built-in camera.

### DESCRIPTION OF DRAWINGS

FIG. 1 is a view illustrating a smartphone equipped with a conventional built-in camera.

FIG. 2 is a view illustrating a laptop computer equipped with a mounted camera such as a conventional webcam.

FIG. 3 is a perspective view illustrating a terminal having a movable built-in camera according to an embodiment of the present invention.

FIG. 4 is a block diagram illustrating a terminal having a movable built-in camera according to an embodiment of the present invention.

FIG. 5 is a view illustrating an example of a camera configuration window according to an embodiment of the present invention.

FIGS. 6 and 7 are views illustrating a change in change unit of a camera direction movement according to a user's face position according to an embodiment of the present invention.

FIG. 8 is a block diagram illustrating a terminal having a movable built-in camera according to another embodiment of the present invention.

FIG. 9 is an exemplary view illustrating a detailed configuration of the direction angle adjustment module shown in FIG. 8.

FIG. 10 is an enlarged view of FIG. 9.

FIG. 11 is a view illustrating a detailed configuration of the electronic drive motor unit shown in FIG. 8.

FIG. 12 is a flowchart illustrating a method of operating the terminal having a movable built-in camera shown in FIG. 8.

FIG. 13 is a view illustrating an example of a computing environment in which one or more embodiments disclosed in the present specification may be implemented.

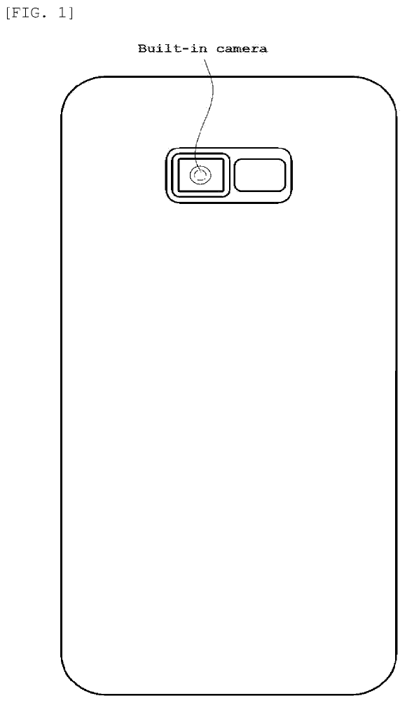

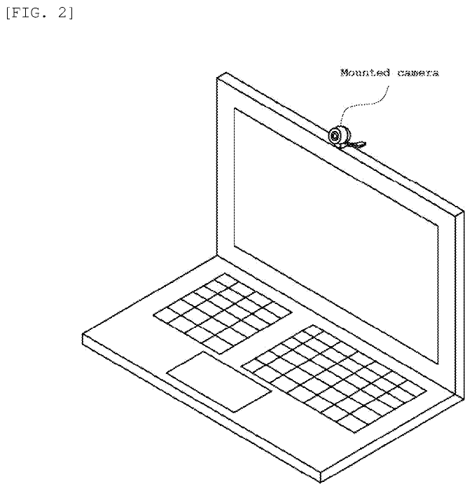

### BEST MODE

### Mode for Invention

Advantages and features of embodiments of the present invention, and method for achieving thereof will be apparent with reference to the accompanying drawings and detailed description that follows. But, it should be understood that the present invention is limited to the following embodiments and may be embodied in different ways, and that the embodiments are given to provide complete disclosure of the present invention and to provide thorough understanding of the present invention to those skilled in the art, and the scope of the present invention is limited only by the accompanying claims and equivalents thereof. In addition, a detailed description of well-known technology will be ruled out in order not to unnecessarily obscure the gist of the present invention.

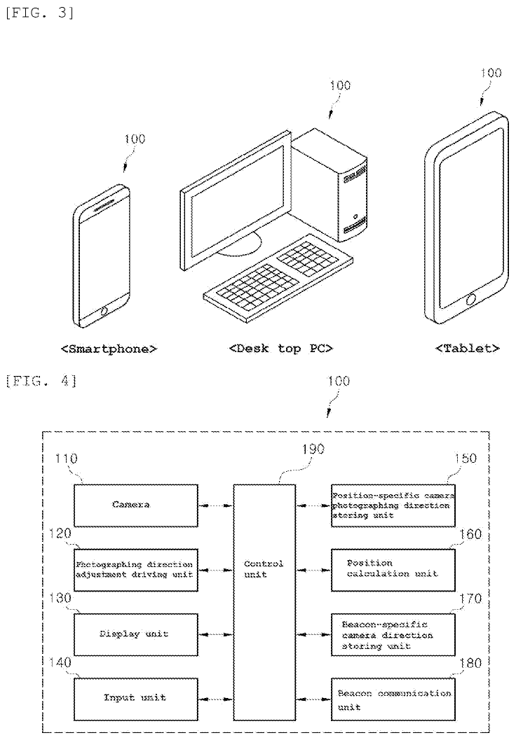

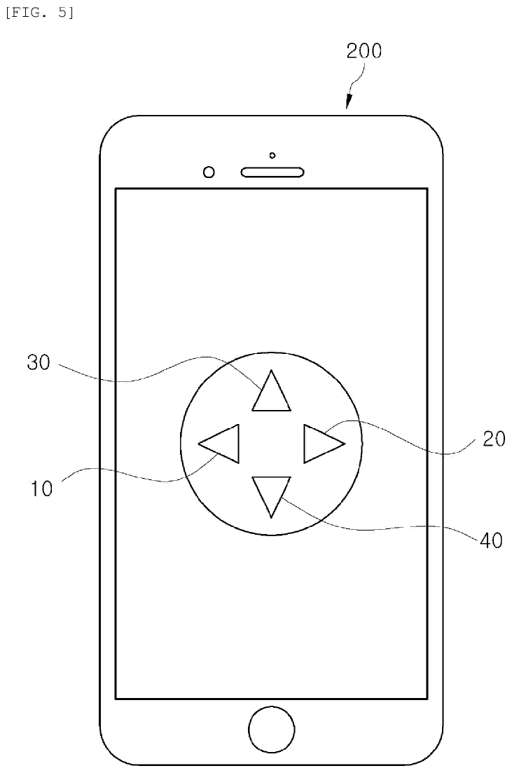

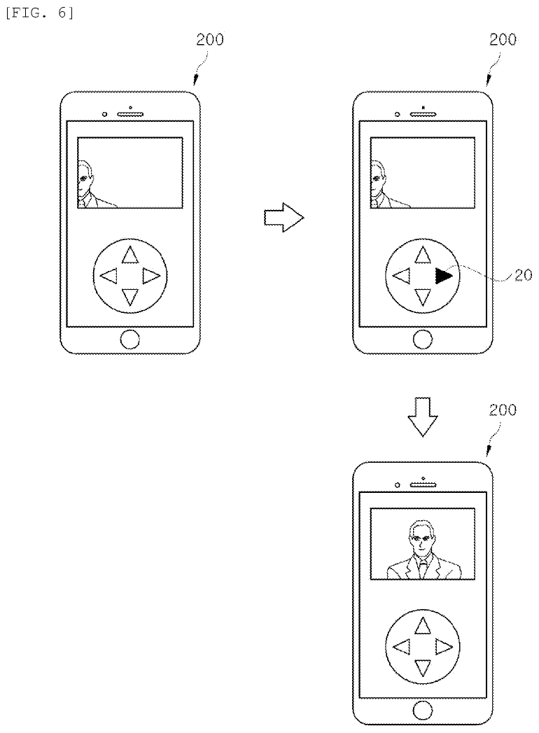

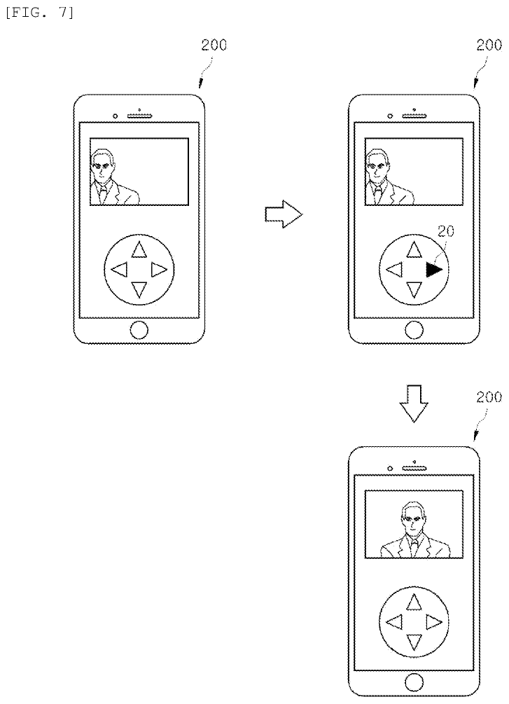

FIG. 3 is a perspective view illustrating a terminal having a movable built-in camera according to an embodiment of the present invention. FIG. 4 is a block diagram illustrating a terminal having a movable built-in camera according to an embodiment of the present invention. FIG. 5 is a view illustrating an example of a camera configuration window according to an embodiment of the present invention. FIGS. 6 and 7 are views illustrating a change in change unit of a camera direction movement according to a user's face position according to an embodiment of the present invention.

The present invention relates to a device and a program that allows a user to move a built-in camera 110 of a terminal vertically or horizontally in a camera 110 environment setting. In this case, as shown in FIG. 3, the terminal may correspond to various terminals such as a smart phone, a tablet PC, a desktop PC, a laptop, and the like.

As shown in FIG. 4, terminal having a movable built-in camera according to the present invention may include the camera 110, a photographing direction adjustment driving unit 120, and a control unit 190. In addition, a display unit 130, an input unit 140, a position-specific camera photographing direction storing unit 150, a location calculation unit 160, a beacon-specific camera direction storing unit 170, and a beacon communication unit 180 may be further included.

In addition, when the terminal having a movable built-in camera is implemented as a communication terminal such as a smart phone, although not shown, a terminal communication unit (not shown) may be further included. The terminal communication unit (not shown) is a module that performs a function of communicating with an external price information providing server 200 through a mobile communication network. When performing mobile communication such as 3G, 4G, etc., the terminal communication unit includes an RF transmitter (not shown) for up-converting and amplifying the frequency of a signal to be wirelessly transmitted and an RF receiver (not shown) for low-noise amplifying a received radio signal and down-converting the frequency of the received radio signal.

In addition, the terminal having a movable built-in camera according to the present invention may further include a data processing unit (not shown) and an audio processing unit (not shown).

The data processing unit (not shown) demodulates and decodes a received signal to extract a data packet, or modulates and encodes the data packet to be transmitted to converts it into a signal. To this end, the data processing unit (not shown) may include a modem and a codec. In this case, the codec may include a data codec for processing data and an audio codec for processing a voice packet and the like and outputting an analog signal of a voice form.

An audio processing unit (not shown) reproduces the audio analog signal output from the audio codec through a speaker (not shown), or converts an audio analog signal input from a microphone (not shown) into a data format to perform the function of transmitting to the audio codec of the data processing unit (not shown). The speaker (not shown) which is means for receiving the voice of a microphone user, outputs a voice signal provided from the audio processing unit (not shown).

The camera 110 is embedded in the terminal to generate a captured image. The camera 110 may include a lens assembly, a filter, a photoelectric conversion module, and an analog/digital conversion module. The lens assembly includes a zoom lens, a focus lens and a compensation lens. The focal length of a lens may be moved under the control of a focus motor (MF). The filter may include optical low pass filter and an infrared cut filter. The optical low pass filter removes optical noise of high frequency components, and the infrared cut filter blocks infrared components of incident light. The photoelectric conversion module may include an imaging device such as a charge coupled device (CCD), a complementary metal-oxide-semiconductor (CMOS), etc. The photoelectric conversion module converts light from the optical system (OPS) into an electrical analog signal. The analog/digital conversion module may include a correlation double sampler and analog-to-digital converter (CDS-ADC) device. The analog/digital conversion module (not shown) processes the analog signal from the photoelectric conversion module (OEC), removes the high frequency noise, adjusts the amplitude, and then, converts it to a digital signal.

The photographing direction adjustment driving unit 120 is a driving member that is built in a terminal and controls the photographing direction of the camera, and is a driver that changes the photographing direction of the camera vertically and horizontally. The photographing direction adjustment driving unit 120 may be implemented with a movement regulator such as a motor, a piezoelectric element, etc., and may adjust the camera 110 vertically and horizontally.

The control unit 190 may be implemented with a main control unit (MCU) that controls each function module of the terminal, and when the terminal is implemented as a smart phone or the like, an application program such as a camera direction control application (APP) may be installed therein. For reference, hundreds of kinds of applications may be installed and added or deleted to a learner terminal 10 implemented as a smart phone or the like as desired by the user, so that the user may directly create a desired application and a suitable interface for himself may be implemented through various applications. Thus, a camera direction control app may be downloaded from Google Market, Apple Store, etc. and installed to a smartphone.

The control unit 190 controls and changes the photographing direction adjustment driving unit 120 in a user manual setting mode in which a user performs a setting or a surrounding environment automatic setting mode.

First, an embodiment in which the control of the photographing direction adjustment driving unit 120 is performed in the user manual setting mode will be described.

The terminal having a movable built-in camera includes a display unit 130 and an input unit 140 in order to control the photographing direction adjustment driving unit 120 in the user manual setting mode.

The display unit 130 is a display window provided on the front of the terminal to displaying a work screen, and displays a graphical user interface (GUI) for communication with the user. The display unit 130 displays a camera environment setting window that receives a camera photographing direction setting.

For example, as shown in FIG. 5, the camera environment setting window in which a direction button is displayed is displayed on the display unit 130.

The input unit 140 receives a camera photographing direction from a user through the camera environment setting window. The input unit 140 and the display unit 130 may be implemented as a touch screen panel through which input and display may be performed together. For reference, the touch screen panel is not only screen display means, but also input means for sensing a touch by touch means such as a touch pen, a finger, etc. For reference, the touch screen panel may be implemented as a touch panel of one of a resistive scheme, a capacitive scheme, an infrared scheme, and an ultrasonic scheme. The touch panel is a transparent switch panel that can control a device by directly pressing a place where a sentence or picture is displayed in combination with a CRT or an LCD.

When operating in the user manual setting mode, the control unit 190 may control the photographing direction adjustment driving unit 120 according to the camera photographing direction input through the camera environment setting window to change the photographing direction of the camera 110. For example, each time the left button 10 is pressed in the camera environment setting window shown in FIG. 5, the camera photographing direction is changed by 2° in the left direction. Each time the right button 20 is pressed once in the camera environment setting window, the camera photographing direction is changed by 20 in the right direction. Each time the upper button 30 is pressed once in the camera environment setting window, the camera photographing direction is changed by 2° in the upward direction. Each time the lower button 40 is pressed once in the camera environment setting window, the camera photographing direction is changed by 2° in the downward direction.

Therefore, the user may change the camera photographing direction to a desired direction by touching the left, right, upper and lower buttons 10 to 40 of the camera environment setting window.

However, the change unit of 2° has been described as an example, but the change unit may be set to various units such as 3°, 4°, 5°, 6°, 7°, etc., by the user.

Furthermore, the change unit may be changed depending on the position of the user's face in the captured image. To this end, the control unit 190 changes the direction by differently changing the changing unit of the photographing direction according to the position of the user's face in the image photographed through the camera 110. The control unit 190 changes the direction by increasing the changing unit of the photographing direction as the position of the user face is outside the captured image.

For example, as shown in FIG. 6, when the right button 20 is pressed once in a state where the position of the use face is placed at an outer periphery of the captured image, the camera photographing direction is changed to the right by about 10°. To the contrary, as shown in FIG. 7, when the right button 20 is pressed once in a state where the position of the user face is more inside than the outer periphery of the captured image, the camera photographing direction is changed to the right by about 4° rather than 10°. This is to reduce the number of button operations of the user by positioning the subject at the center of the captured image faster even with one operation button.

Meanwhile, in order to control the photographing direction adjustment driving unit 120 in the surrounding environment automatic setting mode, the terminal having a movable built-in camera may include the position-specific camera photographing direction storing unit 150 and the location calculation unit 160.

The position-specific camera photographing direction storing unit 150 is a storing medium in which camera photographing directions are allocated and stored for each of position information. The camera photographing direction for each of position information may be set by a user.

For example, in the position information of a classroom, the photographing direction may be assigned to face a blackboard, and in the position information of a house, the photographing direction may be assigned to front at a 45° angle.

For reference, the position-specific camera photographing direction storing unit 150, which is a module, such as a hard disk drive, a solid state drive, a flash memory, a compact flash (CF) card, and a secure digital (SD) card, a smart media (SM) card, a multi-media card, a memory stick, etc., which can input and output information, may be embedded in a device and may be provided in a separated device.

The position calculation unit 160 is a module for grasping a position of the terminal, and may directly receive a position from a user or utilize location information of a GPS or a communication base station.

When operating in the surrounding environment automatic setting mode, the control unit 190 extracts a camera photographing direction assigned to a location of the terminal identified through the position calculation unit 160 from the position-specific camera photographing direction storing unit 150, and controls the photographing direction adjustment driving unit 120 according to the extracted camera photographing direction. Therefore, in a lecture room, the camera 110 is automatically controlled to face forward, and at home, the camera 110 can be automatically controlled to face at an angle of 45°.

In addition, the terminal having a movable built-in camera according to the present invention may automatically determine the photographing direction by using the beacon communication without using the location information. As is known, the beacon communication, which is short-range wireless communication based on Bluetooth (BLE) 4.0 protocol, may communicate with devices within a maximum of 70 m. The beacon communication is accurate enough to distinguish units of 5 to 10 cm. The beacon communication is suitable for IoT implementation where all devices are always connected due to low power consumption. The beacon communication is considered to be the leading part in reviving the Bluetooth technology that was falling, in the IoT era. The Bluetooth technology, which was in the spotlight due to short-range file sharing in the early stage of the introduction of smartphones, was forgotten due to the spread of Wi-Fi networks and the reduction of 3G (3rd generation) and LTE (4th generation mobile communication) rates. The reason Bluetooth was attracting attention again is that O2O service required a fixed location based short-range communication technology different from LTE. The Bluetooth technology has been forgotten in the minds of users, but the Bluetooth technology has come to the light of the IoT era by advancing the technology with perseverance. Beacons have a longer available distance than NFC, which can provide user experience in units of space. Only advantage of Beacon is providing indoor location information that was not possible with GPS technology.

Therefore, recently, theaters and various stores use beacons to provide location information and advertisement information to terminals such as smartphones adjacent.

Therefore, the present invention may be implemented to automatically change the photographing direction by utilizing a beacon signal To this end, the terminal having a movable built-in camera includes a beacon-specific camera photographing direction storing unit 170 for storing a camera photographing direction assigned to each of beacon identification information, and a beacon communication unit 180 for beacon communicating with a beacon device that transmits unique beacon identification information.

Accordingly, when operating in the environment automatic setting mode, the control unit 190 extracts beacon identification information from the beacon-specific camera photographing direction storage unit 170 which is assigned to the beacon identification information received through the beacon communication unit 180, and control the photographing direction adjustment driving unit 120 according to the extracted camera photographing direction.

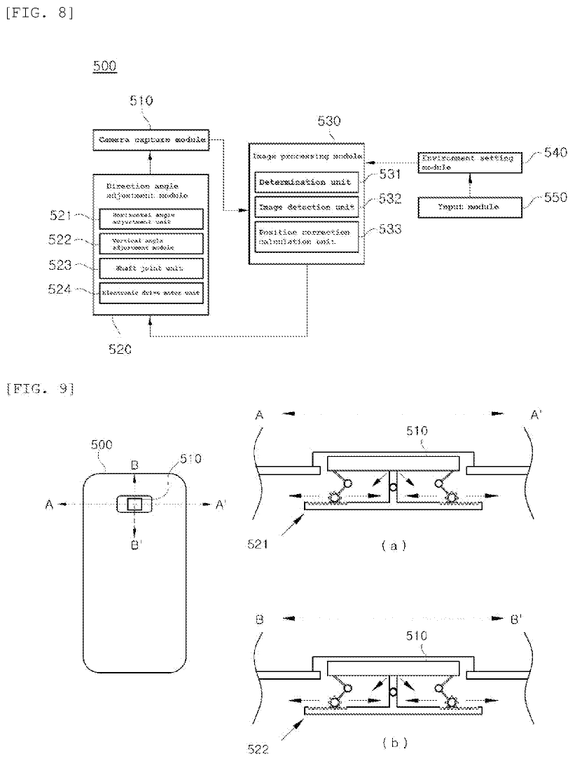

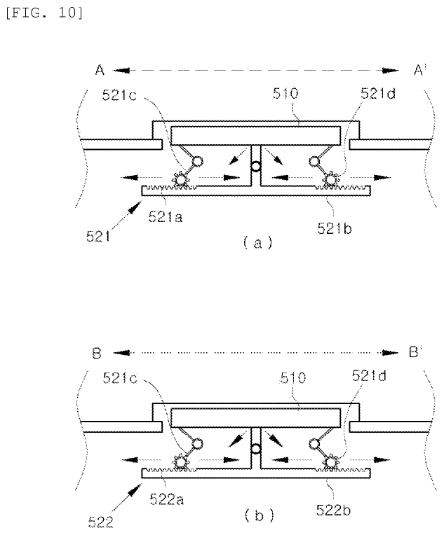

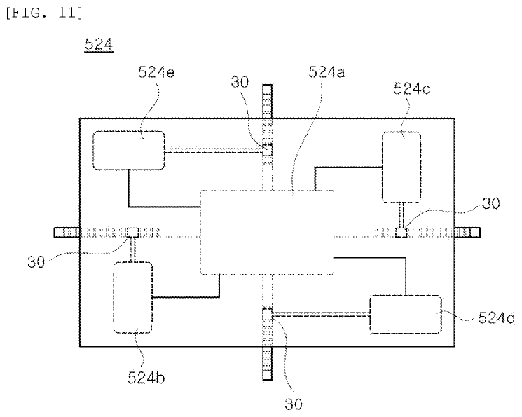

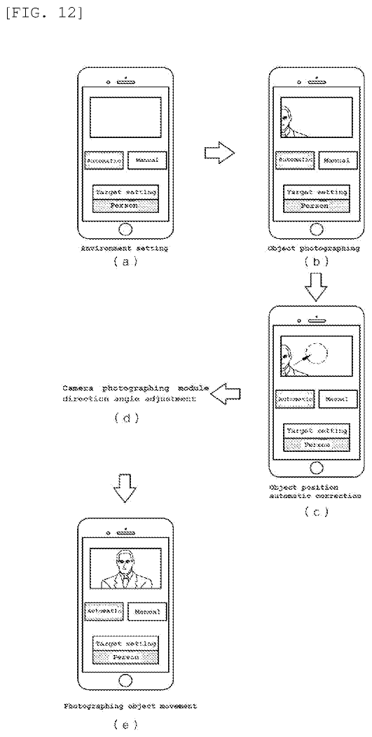

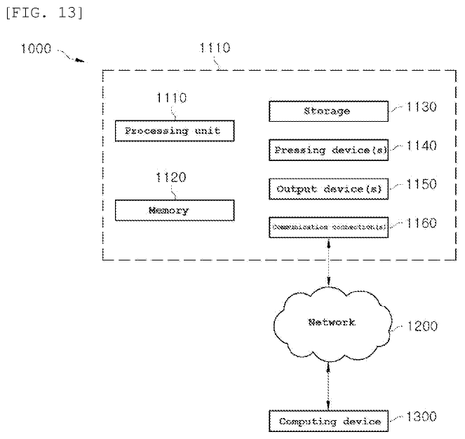

FIG. 8 is a block diagram illustrating a terminal having a movable built-in camera according to another embodiment of the present invention. FIG. 9 is an exemplary view illustrating a detailed configuration of the direction angle adjustment module shown in FIG. 8. FIG. 10 is an enlarged view of FIG. 9. FIG. 11 is a view illustrating a detailed configuration of the electronic drive motor unit shown in FIG. 8. FIG. 12 is a flowchart illustrating a method of operating the terminal having a movable built-in camera shown in FIG. 8.

A terminal 500 having a movable built-in camera according to another embodiment of the present invention shown in FIG. 8 extracts contour line information of a captured object. When the extracted contour line is determined as a face contour line, the terminal 50 moves the camera to position the corresponding contour line at the center of the photographing frame, and corrects the contour focus at the moved position.

In more detail, referring to FIG. 8, the terminal having a movable built-in camera 500 according to another embodiment of the present invention includes a camera capture module 510, a direction angle adjustment module 520, an image processing module 530, an environment setting module 540, and an input module 550.

The camera capture module 510 forms light reflected from the subject and enters the incident light, converts the formed light into an electrical signal, and then converts to generate digital image information (image) for the subject through image signal processing.

The camera capture module 510 may include a lens assembly, a filter, a photoelectric conversion module, and an analog/digital conversion module. The lens assembly includes a zoom lens, a focus lens, and a compensation lens. The focal length of the lens may be moved under the control of the focus motor (MF). The filter may include an optical low pass filter and an infrared cut filter. The optical low pass filter removes optical noise of high frequency components, and the infrared cut filter blocks infrared components of incident light. The photoelectric conversion module may include an imaging device such as a charge coupled device (CCD), a complementary metal-oxide-semiconductor (CMOS), etc. The photoelectric conversion module converts light from the optical system (OPS) into an electrical analog signal. The analog/digital conversion module may include a correlation double sampler and analog-to-digital converter (CDS-ADC) device. The analog/digital conversion module (not shown) processes the analog signal from the photoelectric conversion module (OEC), removes the high frequency noise, adjusts the amplitude, and converts it to a digital signal.

The direction angle adjustment module 520 may be configured to adjust the up, down, left and right rotation angles of the camera imaging module 510.

In more detail, the direction angle adjustment module 520 may include a horizontal angle adjustment unit 521, a vertical angle adjustment unit 522, a shaft joint unit 523, and an electronic drive motor unit 524.

The horizontal angle unit 521 performs a function of rotating the rotation angle (0 to 30 degrees) of the camera capture module 510 in the direction of A-A′.

Referring to (a) of FIG. 9, the horizontal angle adjustment unit 521 includes a first horizontal axis rack gear 521a, a first horizontal axis rack gear 521b, a first horizontal angle joint unit 521c and a second horizontal angle joint unit 521d, which are disposed in the horizontal axis direction of A˜A′ based on the center point of the frame of the camera imaging module 510.

In this case, each of the first and second horizontal angle joint unit 521c and 521d may include a first guide bar 10, a second guide bar 20, a pinion gear 30, and a rotation joint member 40.

For example, the pinion gear 30 of the first horizontal angle joint unit 521c is connected to the first motor rotation shaft of the electronic drive motor unit 524, and the pinion gear 30 of the second horizontal angle joint unit 521d is connected to the second motor rotation shaft of the electronic drive motor unit 524, so that they are rotated in the rotation directions (forward and reverse directions) of each motor rotation shaft.

Next, referring to (b) of FIG. 9, the vertical angle adjustment unit 522 includes s a first vertical axis rack gear 522a, a second vertical axis rack gear 521b, a first vertical angle joint unit 522c and a second vertical angle joint unit 522d, which are disposed in the vertical axis direction of B-B′ based on the center point of the frame of the camera imaging module 510.

In this case, each of the first and second vertical angle joint unit 522c and 522d may include a first guide bar 10, a second guide bar 20, a pinion gear 30, and a rotation joint member 40.

For example, the pinion gear 30 of the first vertical angle joint unit 522c is connected to the third motor rotation shaft of the electronic drive motor unit 524, and the pinion gear 30 of the second vertical angle joint unit 522d is connected to the fourth motor rotation shaft of the electronic drive motor unit 524, so that they are rotated in the rotation directions (forward and reverse directions) of each motor rotation shaft.

Next, one end of the shaft joint unit 523 is connected to the center of the bottom surface of the frame of the camera module 510, and an opposite end is connected to a point where the first and second horizontal axis rack gears, and the first and second vertical axis rack gears.

In addition, the shaft joint unit 523 may freely change the rotation angle of the camera capture module according to the movements of the horizontal and vertical angle units 521 and 522 because a rotation joint member 523-1 having a spherical shape is disposed at the center.

Next, the electronic drive motor unit 524 controls the movement of each of the horizontal and vertical angle adjustment units.

In more detail, the electronic drive motor unit 524 includes a rotation amount calculation unit 524a, and first to fourth rotation motors 524b to 524e.

The rotation amount calculation unit 524a converts a direction vector value generated by the position correction calculation unit 533 to be described later to rotation amounts of the first to fourth rotation motors to calculate the rotation amount of each rotation motor.

The first rotation motor performs the function of rotating the pinion gear of the first horizontal angle joint unit 521c in forward and reverse directions about the rotation shaft. The second rotation motor 524c performs the function of rotating the pinion gear of the second horizontal angle joint unit 521d in the forward and reverse directions about the rotation shaft. The third rotation motor 524d performs the function of rotating the pinion gear of the first vertical angle joint unit 522c in the forward and reverse directions about the rotation shaft. The fourth rotation motor 524e performs the function of rotating the pinion gear of the second vertical angle joint unit 522d in the forward and reverse directions about the rotation shaft.

Each rotation motor rotates the rotation shaft based on the rotation amount calculated by the rotation amount calculation unit.

Next, the image processing module 530 corrects the position of the specific image and corrects the contour line of the specific image such that the position of the specific image captured in the camera capture frame is positioned at the center of the camera capture frame based on the environment setting information.

In more detail, the image processing module 530 includes a determination unit 531, an image detection unit 532, and a position correction calculation unit 533.

The determination unit 531 determines whether the setting value (capture target) of the environment setting module 540 corresponds to a person

The determination unit 531 may determine the photographing target by using an AI algorithm of one of machine learning one of supervised learning, unsupervised learning, semi-supervised learning, deep learning using a neural network, and mathematical algorithm based machine learning, or at least one combination thereof.

In this case, the type of the intelligent learning algorithm is largely classified into two learning schemes depending on whether label data exist in learning data. The supervised learning algorithm uses the learning data which have a label, and the unsupervised learning algorithm uses learning data which do not have a label. The supervised learning algorithm has a large amount of computation and complicated formulas, so it has low learning speed and difficulty in implementation. However, for superior performance than the unsupervised learning algorithm, the supervised learning algorithm takes a lot of time and time to acquire a label of the learning data, but the supervised learning algorithm is used in many fields. To the contrary, the unsupervised learning algorithm has a small amount of computation and a simple formula, so that the learning speed is fast and the implementation is simple. However, because the unsupervised learning algorithm is inferior in performance to the supervised learning algorithm, research has been conducted to overcome it. Recently, a semi-supervised learning algorithm, which has an intermediate form, is drawing attention to overcome the disadvantages of the supervised learning algorithm and the supervised learning algorithm. The semi-supervised learning algorithm learns using the small number of labeled learning data and the large number of unlabeled learning data, and shows the characteristics of the high performance of the existing supervised learning algorithm and the fast learning speed of the unsupervised learning algorithm. Until now, the study on the semi-supervised learning algorithm has the tendency that only a small number of label data is adopted from the supervised learning algorithm and data processing with no label is added to an existing function or label data processing is added to the unsupervised learning algorithm. As label data decreases, the time and cost of label processing decreases, but the reliability of selecting the small number of label data is very important because the amount of actual data has increased significantly compared to the past.

Therefore, the determination unit 531 of the present invention may further use a vector centroid neural network (VCNN), which is an unsupervised competitive learning algorithm, in selecting label data for the semi-supervised learning algorithm in addition to the above-mentioned supervised learning. The VCNN may minimize the occurrence of loser neurons by adding vector theory when an additional representative value is input in the existing centroid neural network (CNN) algorithm operation, and may obtain more stable learning results than the existing CNN even in repetitive learning. As a learning algorithm, semi-supervised spatially variant dissimilarity measure (SSSVaD) and supervised learning algorithm SVM may be arranged as a semi-supervised learning scheme based on an unsupervised learning algorithm. Of course, various AI learning schemes may be used in addition to the above-described AI learning scheme, but it will be apparent that the present invention is not limited to the above-described embodiment.

Next, when the photographing target is a person, the image detection unit 532 divides the image captured in the camera capture frame into sub-areas, and then, detects contour lines of each sub-area based on the boundary values of pixels in the sub-areas.

The image detection unit 532 may use a data mining technique, an artificial neural network deep learning technique, or a cluster analysis technique to detect the contour line of each sub-area.

For reference, the artificial neural network deep learning technique may use a convolutional neural network (CNN) structure. The CNN is suitable to process an image in a network structure using a convolutional layer because the image can be classified based on a feature in the image by using the image data as an input.

In addition, text mining is a technology for the purpose of extracting and processing useful information based on a natural language processing technology from non/semi-structured text data. It is possible to extract meaningful information from a large bunch of text through text mining technology, grasp the linkage with other information, find categories of text, or get more than just searching for information.

When a face contour line is included among at least one contour line detected in each sub-area, the position correction calculation unit 533 calculates the separation distance between the corresponding sub-area and the central area of the photographing frame and then, generates a direction vector value corresponding to the calculated separation distance.

Next, the environment setting module 540 performs a function of setting the type of an object to be automatically/manually photographed by the terminal 500 having a movable built-in camera.

The environment setting module 540 may cooperate with the input module 55 for selecting an automatic mode, a manual mode, and an object to be photographed.

The input module 550 may be implemented with a touch screen panel displaying a mode selection button and an object selection button. For reference, the touch screen panel is not only screen display means, but also input means for sensing a touch through touch means such as a touch pen or a finger. For reference, the touch screen panel may be implemented with a touch panel of one of a resistive scheme, a capacitive scheme, an infrared scheme, and an ultrasonic scheme. The touch panel is a transparent switch panel that can control a device by directly pressing a place where a sentence or picture is displayed in combination with a CRT or an LCD.

FIG. 13 is a view illustrating an example of a computing environment in which one or more embodiments disclosed in the present specification may be implemented, where an example of a system 1000, which includes a computing device 1100 configured to implement one or more of the embodiments described above, is illustrated. For example, the computing device 1100 may include a distributed computing environment including a personal computer, a server computer, a handheld or laptop device, a mobile device (such as a mobile phone, a PDA, a media player, etc.), a multiprocessor system, a consumer electronic device, a mini-computer, a main frame computer, an arbitrary system, or devices described above, but the embodiment is not limited thereto.

The computing device 1100 may include at least one processing unit 1110 and a memory 1120. In this case, the processing unit 1110 may include, for example, a central processing unit (CPU), a graphics processing unit (GPU), a microprocessor, an application specific integrated circuit (ASIC), or field programmable gate arrays (FPGA), and may have multiple cores. The memory 1120 may be a volatile memory (e.g., RAM, etc.), a non-volatile memory (e.g., ROM, flash memory, etc.) or a combination thereof. Further, the computing device 1100 may include additional storage 1130. The storage 1130 includes magnetic storage, optical storage, and the like, but the embodiment is not limited thereto. Computer-readable instructions for implementing one or more embodiments disclosed in the present specification may be stored in the storage 1130, and may store other computer-readable instructions for implementing an operating system, an application program, and the like. Computer readable instructions stored in the storage 1130 may be loaded into the memory 1120 to be executed by processing unit 1110. In addition, the computing device 1100 may include an input device (s) 1140 and an output device (s) 1150.

In this case, the input device (s) 1140 may include, for example, a keyboard, a mouse, a pen, a voice input device, a touch input device, an infrared camera, a video input device, any other input devices, etc. In addition, the output device (s) 1150 may include, for example, one or more displays, speakers, printers, any other output devices, etc. In addition, the computing device 1100 may use an input device or output device provided in another computing device as the input device (s) 1140 or the output device (s) 1150.

In addition, the computing device 1100 may include a communication connection (s) 1160 that enables the computing device 1100 to communicate with other devices (e.g., the computing device 1300).

In this case, the communication connection (s) 1160 may include another interface for connecting a modem, a network interface card (NIC), an integrated network interface, a radio frequency transmitter/receiver, an infrared port, a USB connection, the computing device 1100 to another computing device. In addition, the communication connection (s) 1160 may include a wired connection or a wireless connection. Each component of the above-described computing device 1100 may be connected by various interconnections such as a bus (e.g., a peripheral component interconnection (PCI), a USB, a firmware (IEEE 1394), an optical bus structure, etc.), and may be interconnected by the network 1200. The terms ‘component’, ‘system’ and the like used in the specification generally refer to hardware, a combination of hardware and software, software, or a computer-related entity which is executing software.

For example, a component may be a process executing on a processor, a processor, an object, an executable material, an executing thread, a program and/or a computer. For example, both the application executing on a controller and the controller may be components. One or more components may exist in a processor and/or an executed thread, may be localized on one computer, or may be distributed between two or more computers.

The present invention is not limited by the above-described embodiments and the accompanying drawings. It should be understood that numerous other modifications and embodiments can be devised by those skilled in the art that will fall within the spirit and scope of the principles of this disclosure.

### DESCRIPTION OF REFERENCE NUMERAL

### First Embodiment

100: Terminal having movable built-in camera
110: Camera
120: Photographing direction adjustment driving unit
190: Control unit

### Second Embodiment

500: Terminal having movable built-in camera
510: Camera capture module
520: Direction angle adjustment module
521: Horizontal angle adjustment unit
521a: First horizontal axis rack gear
521b: Second horizontal axis rack gear
521c: First horizontal angle joint unit
521d: Second horizontal angle joint unit
522: Vertical angle adjustment module
522a: First vertical axis rack gear
522b: Second vertical axis rack gear
522c: First vertical angle joint unit
522d: Second vertical angle joint unit
523: Shaft joint unit
524: Electronic drive motor unit
524a: Rotation amount calculation unit
524b: First rotation motor
524c: Second rotation motor
524d: Third rotation motor
524e: Fourth rotation motor
530: Image processing module
531: Determination unit
532: Image detection unit
533: Position correction calculation unit
540: Environment setting module
550: Input module

1. A terminal having a movable built-in camera, the terminal comprising:
a camera capture module configured to form an image of incident light reflected from a subject, and convert the formed image of light into an electrical signal to generate digital image information of the subject through image signal processing;
a direction angle adjustment module configured to adjust vertical and horizontal rotation angles of the camera capture module;
an image processing module configured to correct a position of a specific image captured within a camera capture frame to position the specific image at a center of the camera capture frame based on environment setting information; and
an environment setting module configured to provide the environment setting information.

2. The terminal of claim 1, wherein the direction angle adjustment module includes:
a horizontal angle adjustment unit configured to rotate the horizontal rotation angle of the camera capture module;
a vertical angle adjustment unit configured to rotate the vertical rotation angle of the camera capture module;
a shaft joint unit coupled to a center of a bottom surface of a frame of the camera capture module, and rotate in rotational directions of the horizontal and vertical angle adjustment units; and
an electronic drive motor unit configured to adjust movement of each of the horizontal and vertical angle adjustment units.

3. The terminal of claim 2, wherein the image processing module includes:
a determination unit configured to determine whether a setting value of the environment setting module corresponds to a person being a capture target;
an image detection unit configured to divide an image captured in the camera capture frame into sub-areas when the person is the capture target, and detect a contour line of each sub-region based on boundary values of pixels in the sub-area; and
a position correction calculation unit configured to calculate a distance between a corresponding sub-area and a central area of the capture frame and generate a direction vector value corresponding to the calculated distance, when a face contour line is included in at least one contour line detected in each sub-area.

4. The terminal of claim 3, wherein the electronic drive motor unit includes:
a rotation amount calculation unit configured to convert the direction vector value generated by the position correction calculation unit into rotation amounts of first to fourth rotation motors to calculate a rotation amount of each rotation motor;
a first rotation motor configured to rotate a pinion gear of a first horizontal angle joint unit in forward and reverse directions based on the rotation amount calculated by the rotation amount calculation unit;
a second rotation motor configured to rotate a pinion gear of a second horizontal angle joint unit in the forward and reverse directions based on the rotation amount calculated by the rotation amount calculation unit;
a third rotation motor configured to rotate a pinion gear of a first vertical angle joint unit in the forward and reverse directions based on the rotation amount calculated by the rotation amount calculation unit; and
a fourth rotation motor configured to rotate a pinion gear of a second vertical angle joint unit in the forward and reverse directions based on the rotation amount calculated by the rotation amount calculation unit.
